(19) United States
(12) Patent Application Publication
(10) Pub. No.: US 2012/0035973 A1
(43) Pub. Date: Feb. 9, 2012

(54) COMPUTERIZED DYNAMIC CAPACITY MANAGEMENT SYSTEM AND METHOD

(75) Inventors: Patrick Bradford, Powell, OH (US); Tami Koenig, Spencerville, OH (US); Kevin Cordonnier, Versailles, OH (US); Joe Buckmaster, Dublin, OH (US); Jim Ballinger, Lima, OH (US); David Ladd, Rainbow City, AL (US); John Gale, Columbus, IN (US); Al Gilstorf, Mt. Forest (CA)

(73) Assignee: HONDA MOTOR CO., LTD., Tokyo (JP)

(21) Appl. No.: 13/205,427

(22) Filed: Aug. 8, 2011

Related U.S. Application Data
(60) Provisional application No. 61/371,566, filed on Aug. 6, 2010.

(51) Int. Cl. G06Q 10/06; G06Q 10/04

(52) U.S. Cl. 705/7.22

(57) ABSTRACT

A computerized system and method facilitates the collection, calculation, and analysis of supplier capacity data. Using portal technology, communications between the manufacturer and suppliers related to capacity data are facilitated. The system and method accommodate numerous supplier manufacturing processes and their unique configurations so that consistent “standard’ and “maximum” capacity values may be calculated. The portal supports data entry to quickly, efficiently, and accurately identify capacity constraints at the process and part number levels, create solutions, and monitor the implementation of solutions to increase capacity. Using dynamic calculation logic, fluctuating demand values for parts are considered in determining probable capacity values. The impact of various investments on production capacity may also be assessed. The manufacturer may further use capacity constraint data to adjust production to sales or market changes and to align production with capacity.

### CROSS-REFERENCE TO RELATED APPLICATION

This application is a non-provisional patent application claiming the priority benefit of U.S. Provisional Patent Application Ser. No. 61/371,566, filed Aug. 6, 2010, titled COMPUTERIZED DYNAMIC CAPACITY MANAGEMENT SYSTEM AND METHOD, which is incorporated herein by reference in its entirety.

### BACKGROUND

Many manufacturers today devote substantial resources to developing product lines to address the needs and desires of very different consumer groups. Satisfying consumer demands often requires manufacturers to develop products that meet not only consumers' functional requirements but also their aesthetic requirements. Many manufacturers address the need for multiple products and product lines by developing base products and then configuring them in various ways during production to meet needs in different consumer market segments.

Although the ability to modify and adapt products for consumer needs and demands can help a manufacturer to acquire or increase market share, responding quickly to consumer needs and demands can be difficult. For example, if demand for a certain product increases unexpectedly, the manufacturer must be able to increase production for the specific product, and component parts, to respond to the increase in demand. For manufacturers that rely on multiple suppliers, increasing production may require a commensurate increase in component parts from suppliers. It is important therefore, for the manufacturer to know whether its suppliers are prepared to respond to an increase in demand for parts to meet the increase in demand for its products.

Some manufacturers in the automotive industry have adopted various processes for evaluating the capacity of their suppliers. Capacity data for suppliers may be communicated to a sales organization that analyzes sales demand data and forecasts future sales demand for the manufacturer's products. The sales organization may further have the responsibility of issuing sales demand orders for production of automobiles for the forecasted sales demand. The supplier capacity data assists the sales organization in issuing sales demand orders that the various facilities or factories of the manufacturer use in establishing production schedules.

To determine a specific capacity quantity of parts or pieces per a weekly production time, an automotive manufacturer obtains multiple and varied inputs from each supplier. At supplier locations, production processes, lines, and/or machines are designed to manufacture multiple variations of specific OEM part(s). Each variation of the part(s) may have a different cycle time. Therefore, an accurate capacity measurement must account for the different cycle times of the parts. Many other factors are considered in analyzing capacity. The complexity of data is difficult to control and manage for a variety of reasons.

One reason the data is complex is that automotive manufacturers typically produce different automobiles in factories for or located in different geographic regions and therefore, issue different requirements to parts suppliers even though there may be similarities between the products that are manufactured. Each factory may have more than 500 suppliers that produce thousands of parts. Variations of similar parts allow the manufacturer to produce a variety of different products that address needs in different consumer markets. The lack of standard parts requirements across all factories and suppliers, however, can make capacity data collection and analysis difficult.

Another problem is a lack of tools for analyzing the data that is collected. Spreadsheets may be used to facilitate data collection but they do not seamlessly support data aggregation and analysis. The data aggregation, review, and analysis functions are primarily manual as there is little computerized functionality for receiving data from spreadsheets and performing calculations that may be needed. Various individuals may access the data in the spreadsheets but may reach different conclusions regarding supplier capacity based on the data they access, the tools they use (if any), and the assumptions they make. For example, “standard” capacity output values and “maximum” capacity values for a group of parts produced on the same supplier manufacturing line (referred to as a process) may vary if the parts have differing cycle times. To produce sufficiently accurate values, capacity calculation logic should account for cycle time differences.

Probable “standard” and “maximum” capacity values for the group of parts is also impacted by fluctuations in demands for the parts. For a variety of reasons, demands for parts within a factory may fluctuate during a production period. Fluctuations in production demand typically are not communicated to individuals involved in capacity analysis as there is no means for efficiently communicating the production demand changes for thousands of parts for which details are contained in thousands of spreadsheet files.

The inability to obtain accurate and timely capacity data can impact the ability of the automotive manufacturer to respond to changes in demand for its products. For automobile manufacturers that rely on sales demand orders, even minor misrepresentations of capacity values directly impact the ability to set the appropriate vehicle demand order. Misstated capacity values (whether too high or too low) could incorrectly constrain sales demand orders and therefore, the ability of the manufacturer to meet consumer demand. The inaccurate capacity data may result in the creation and release of demand orders that further strain a supplier's production capability thereby creating quality and delivery issues that result in unplanned expenses or that a supplier cannot fulfill. The supplier order may then need to be revised which can jeopardize other operations.

There is a need for a computerized capacity management system and method that facilitates the collection and analysis of supplier capacity data. There is a need for a computerized capacity management system and method that centralizes and standardizes supplier capacity data analysis to produce more accurate and timely capacity values. There is a need for a computerized capacity management system and method that responds to updates in supplier demand data and facilitates the calculation of new capacity values in response to changes. There is a need for a computerized capacity management system and method that provides accurate and timely information to a sales organization to facilitate creation and distribution of accurate and timely sales demand orders.

### SUMMARY

A computerized system and method for the present disclosure facilitates the collection, calculation, and analysis of supplier capacity data. In an example embodiment, it is implemented using portal technology to facilitate communication between the manufacturer and suppliers. One or more software applications are further linked to demand planning tools and systems. The system and method accommodate numerous supplier manufacturing processes and their unique configurations so that consistent “standard” and “maximum” capacity values may be calculated. Using dynamic calculation logic, fluctuating demand values for parts are considered in determining probable capacity values.

The use of portal technology allows multiple manufacturer factories as well as hundreds of suppliers to use the same software application or applications. The same capacity validation process may be applied to new model as well as mass production products. The system and method may further be linked to planning tools such as an Advance Planning System (APS) that provides consolidated vehicle and part demand views and facilitates comparisons of demand and capacity data to balance demand with supplier capacity. The computerized APS may provide a variety of features and functionality that support various aspects of production planning and scheduling and in particular, allocation of production capacity to meet demand.

The portal supports data entry to quickly, efficiently, and accurately identify capacity constraints at the process and part number levels, create solutions, and monitor the implementation of solutions to increase capacity. The centralized approach allows individuals at the manufacturer as well as supplier side to enter and view data and to monitor developments. Purchasing functions are also enhanced as the system and method supports isolation of absolute or certain capacity constraints and determining corrective measures in a timely manner (e.g., within a three to four week timeframe). The manufacturer may further use the capacity constraint data to adjust production to sales or market changes.

### BRIEF DESCRIPTION OF THE DRAWINGS

FIGS. 1A-1B are sample manufacturer screen displays for an example embodiment;

FIGS. 2A-2G are sample supplier screen displays for an example embodiment;

FIGS. 3A-3C are sample screen displays illustrating details of a probable capacity analysis for an example embodiment;

FIGS. 4A and 4B illustrate reporting features for an example embodiment;

FIG. 5 is a schematic diagram of APS and capacity management servers for an example embodiment;

FIG. 6A is a sample dynamic capacity impact calculation details screen for an example embodiment;

FIGS. 6B and 6C illustrate details of demand/capacity balancing for an example embodiment; and

FIG. 7 is a sample balancing results screen display for an example embodiment.

### DETAILED DESCRIPTION

In a computerized capacity management system and method for an example embodiment, input data for each supplier is collected and stored in a database under a supplier identifier. Supplier location information may also be stored with the supplier identifier. Details for each supplier process at the supplier location are collected and stored. Process identifying information such as a process or line name identifies each supplier process for which data is collected, stored, and analyzed. Part data for the parts that are produced for the process is also recorded Additional input relates to numerous manufacturing process characteristics such as number of production shifts, time allocated to manufacturing, process efficiency ratio, number of work days, part numbers produced, cycle times, and part number demand. Various capacity calculation parameters such as workload and work time parameters (e.g., number of lines/cells, number of shifts per day, total hours/shift, planned daily work time, daily loading time, actual daily operating time, etc.), and efficiency parameters may be used in capacity calculations.

In an example embodiment, the following input data is collected:

TABLE 1
Supplier Process Input

Process Equipment Information
Number of Hours/Shift
Number of Shifts/Day
Standard Number of Days/Week
Maximum Number of Days/Week
Number of Lines or Cells
Standard Number of Hours/Week
Maximum Number of Hours/Week
Average Weekly Production Time for non-manufacturer Parts
Planned Daily Work Time
Planned Daily Break Time
Average Planned Daily Downtime
Average Unplanned Daily Downtime
Average Daily Output (Actual Production)
Average Daily Scrap
Standard Ideal Cycle Time
Part number

linked for manufacturer parts
keyed for non-manufacturer parts
keyed for manual parts

Monthly Part Demand

linked for manufacturer parts
keyed for non-manufacturer parts
keyed for manual parts

Cycle Time

Selected inputs are used in mathematical equations that calculate “standard” and “maximum” capacity values in quantity of parts. In alternative embodiments, capacities may be expressed in other units. Several intermediate calculations are completed prior to the completing the capacity calculations. In an example embodiment, the following values are calculated for use in the capacity calculations.

TABLE 2
Calculated Inputs

Total Planned Daily Non-Work Time
Daily Loading Time
Actual Daily Operating Time
Operating Rate
Performance Rate
Quality Rate
Efficiency - OEE
Monthly Time Consumed on Process
Weighted Average Cycle Time for Process

Outputs of the computerized capacity management system and method include monthly standard capacity and monthly maximum capacity. In an example embodiment, a specific capacity calculation formula for a monthly standard capacity for an 18 month production period is as follows:

TABLE 3
Monthly Standard Capacity for an 18 Month Production Period

((((((standard number of hours/week <sum for all lines> - “average
weekly production time for non-manufacturer parts (hours)”<sum
for all lines>)) * (daily load time/planned daily work time) *
60 *60)/weighted average cycle time for process) * OEE %)/
standard working days in a week) * working days in the
month) * (remaining calendar days in the calculated month starting
from effective date/total calendar days in the calculated month)

In an example embodiment, a specific capacity calculation formula for a monthly maximum capacity for an 18 month production period is as follows:

TABLE 4
Monthly Maximum Capacity for an 18 Month Production Period

((((((maximum number of hours/week <sum for all lines> - “average
weekly production time for non-manufacturer parts (hours)”<sum
for all lines>)) * (daily load time/planned daily work time) *
60 *60)/weighted average cycle time for process) * OEE %)/
standard working days in a week) * working days in the
month) * (remaining calendar days in the calculated month starting
from effective date/total calendar days in the calculated month)

A manufacturer obtains supplier process input data by asking suppliers to respond to capacity requests. A manufacturer may ask all suppliers to provide process input data or may select certain suppliers to respond to capacity requests based on various considerations such as the significance of the parts supplied by the supplier. The manufacturer may further require all suppliers to update their responses according to a defined schedule or the manufacturer may ask selected suppliers to update responses on demand. The strategy that a manufacturer uses to request and update responses may vary depending upon the needs of the manufacturer, the types of products manufactured by the manufacturer, the number of suppliers, the number of parts, the types of parts from the suppliers, etc.

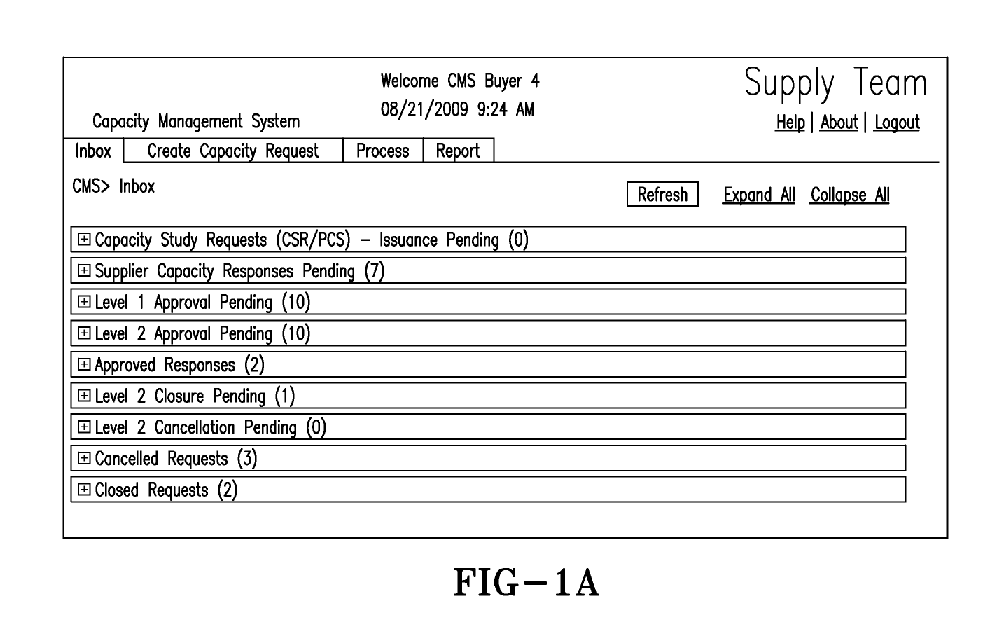

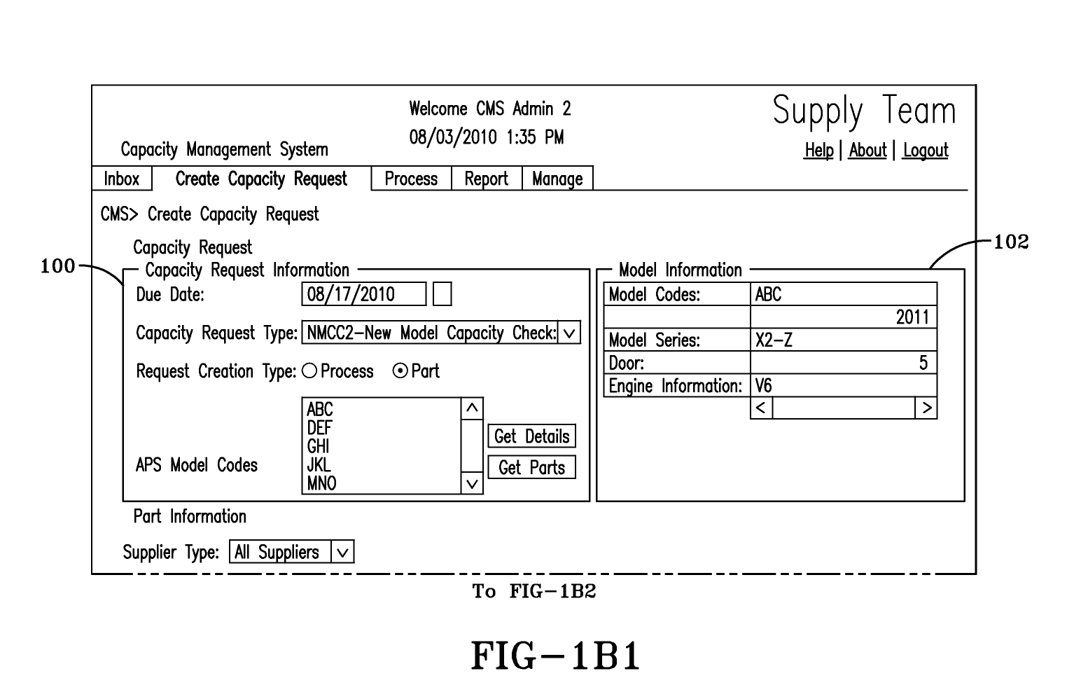

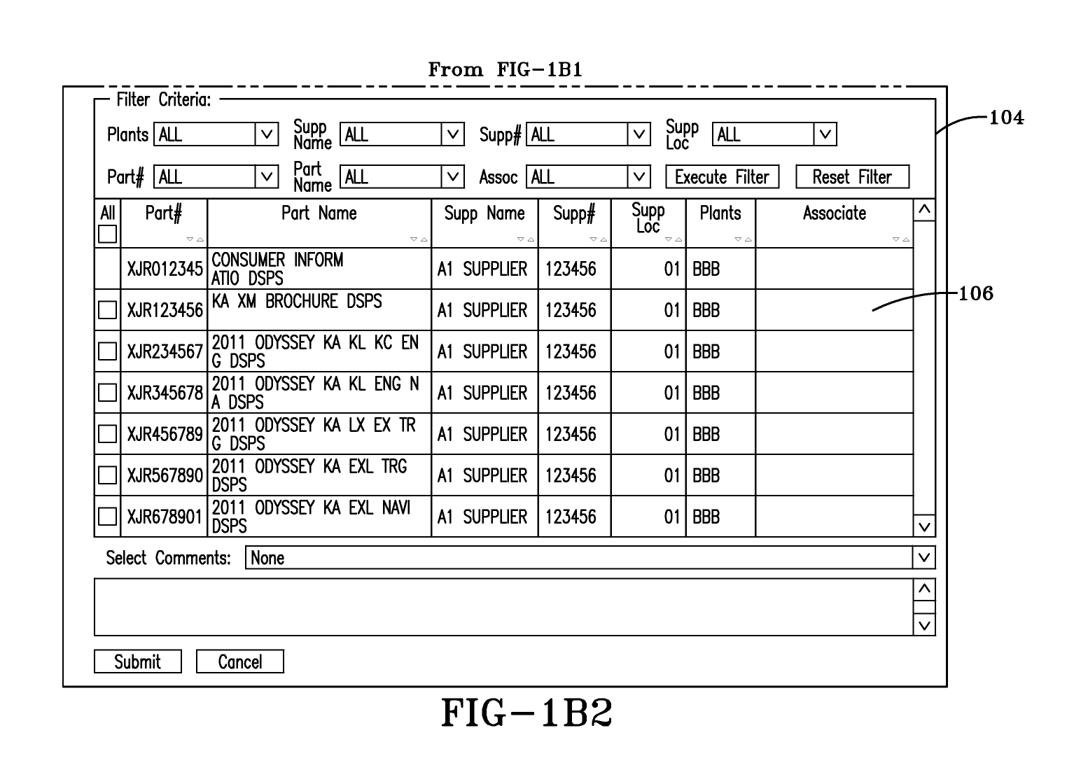

Referring to FIGS. 1A-1B, sample manufacturer screen displays for an example embodiment are shown. Referring to FIG. 1A, a sample inbox screen display for a manufacturer representative is shown. In an example embodiment, capacity data collection and analysis is managed through various activities and tasks performed by users of the computerized system and method. In an example embodiment, the data collection process begins with a capacity request. As responses are prepared and completed, they progress through a series of stages. Requests and responses are organized in an inbox according to stages. A user of the computerized system and method may view items at a particular stage in the analysis by selecting a stage from the inbox. The number of requests or responses at each stage is also shown. In an example embodiment, the stages are:

TABLE 5
Capacity Request Stages

Capacity Study Requests - Issuance Pending
Supplier Capacity Responses Pending
Level 1 Approval Pending
Level 2 Approval Pending
Approved Responses
Level 2 Closure Pending
Level 2 Cancellation Pending
Cancelled Requests
Closed Requests

Referring to FIG. 1B, a sample create capacity request display screen for an example embodiment is shown. Details regarding the capacity request may be provided in a capacity request information section 100. Each capacity request may have a due date for receiving supplier input, a request type (e.g., new model or mass production), a request creation type (e.g., process or part), and a related model code. Details of the model for which the process is executed or part is produced may be provided in a model information section 102.

In a filter criteria section 104, a user may input selection or filter criteria related to capacity requests. Capacity requests that match the selection or filter criteria are displayed in a list 106. As indicated in FIG. 1B, requests may be sorted by part number.

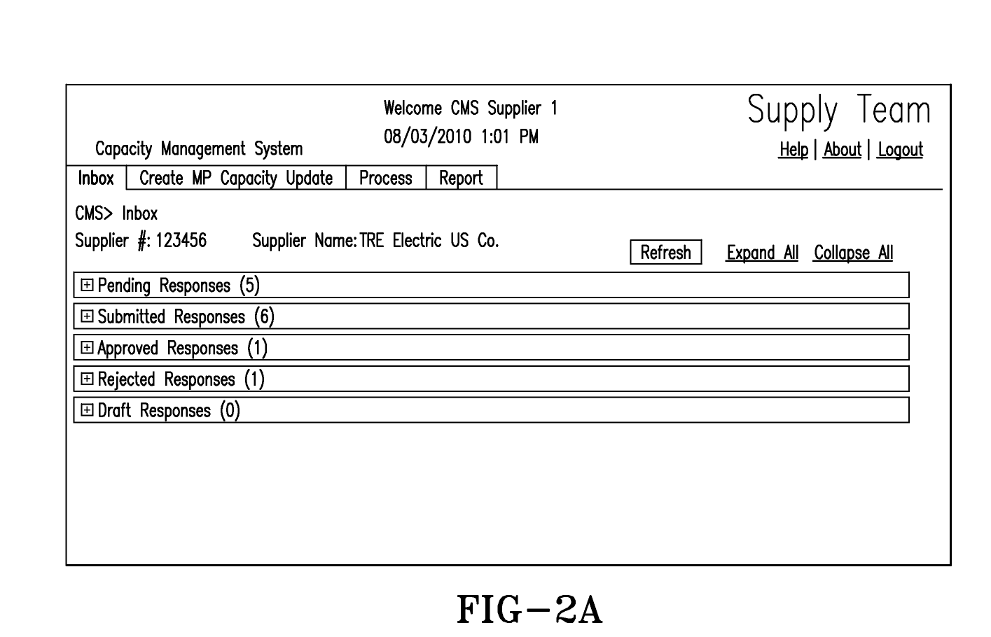

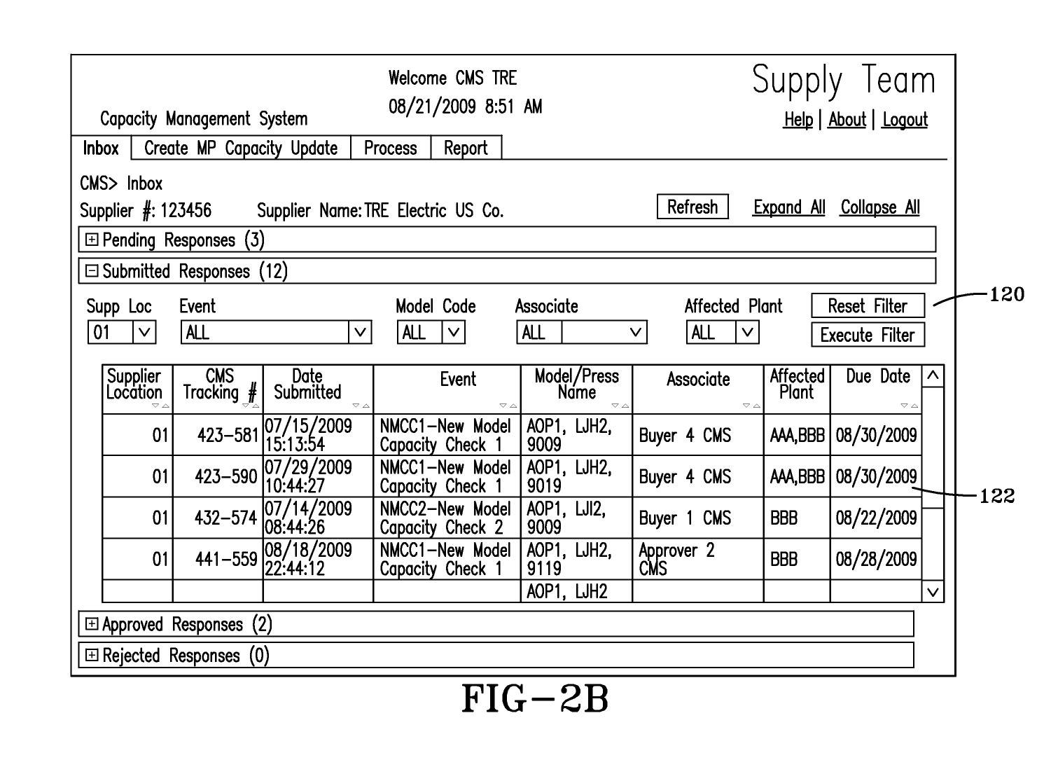

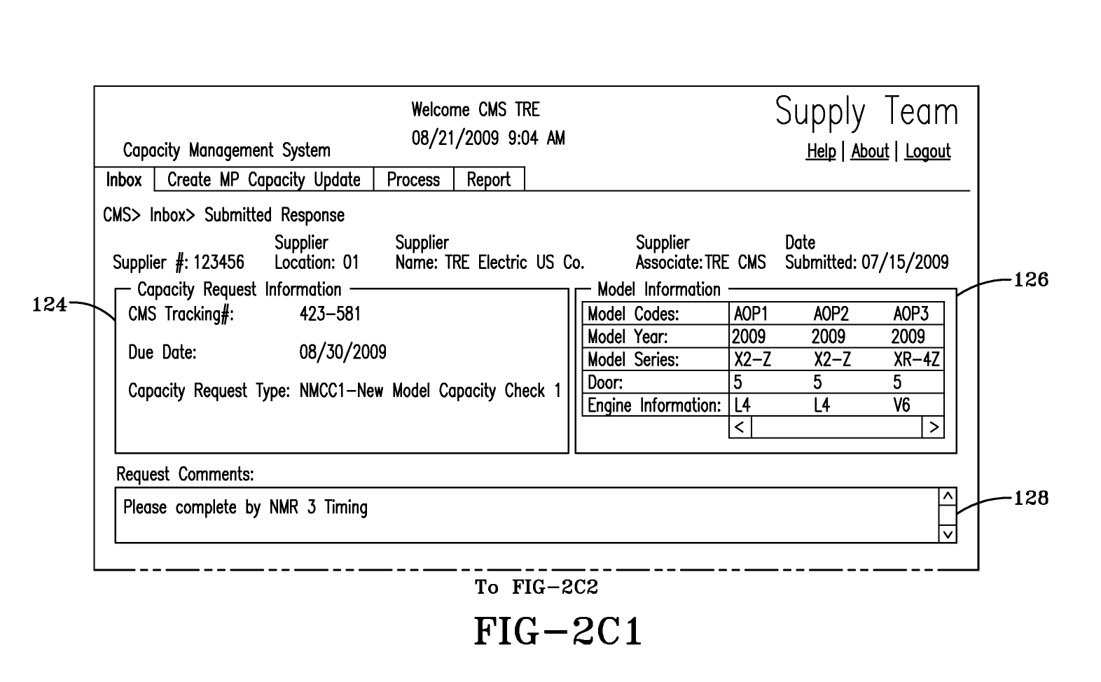

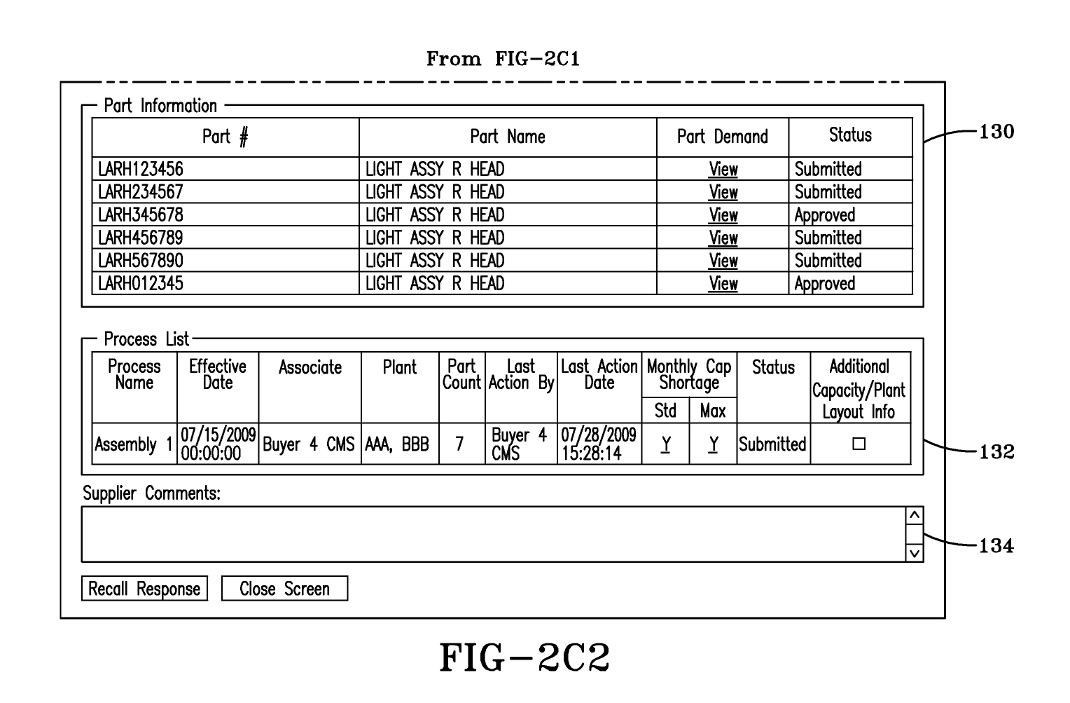

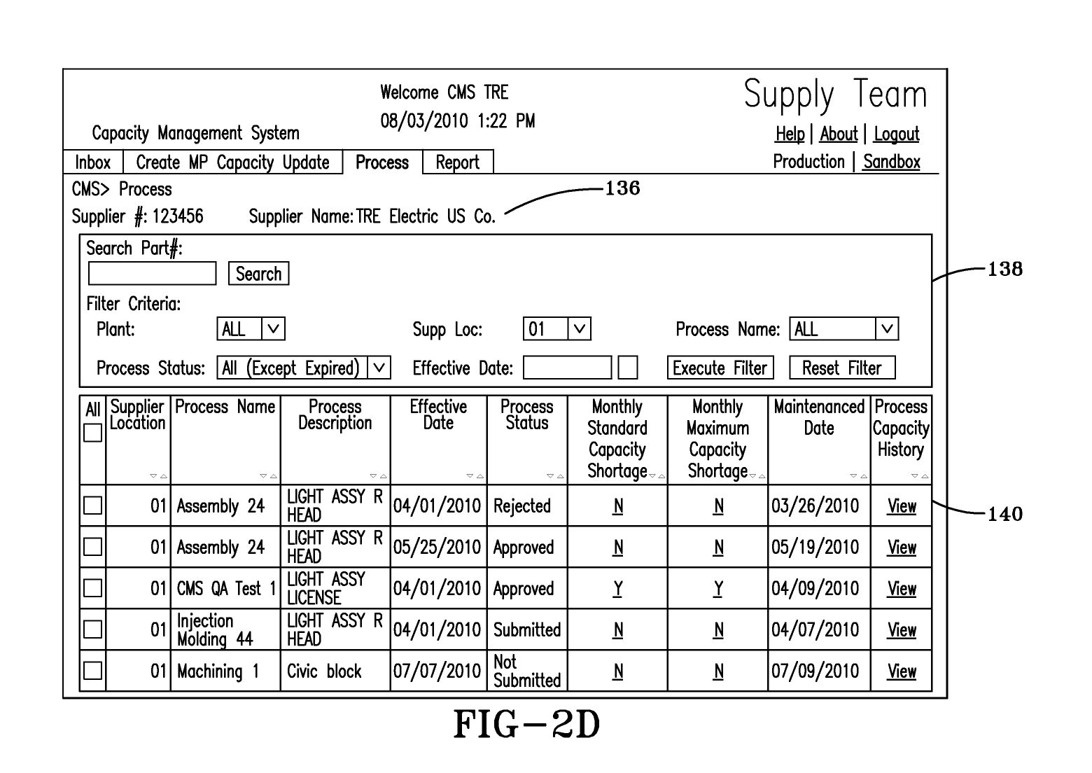

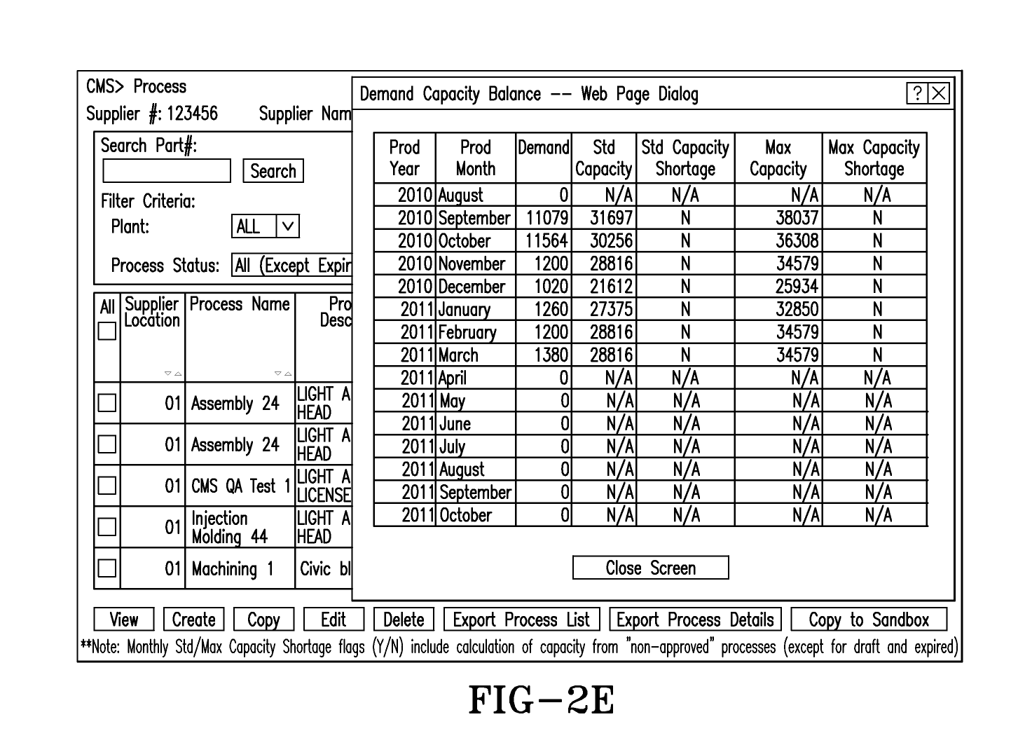

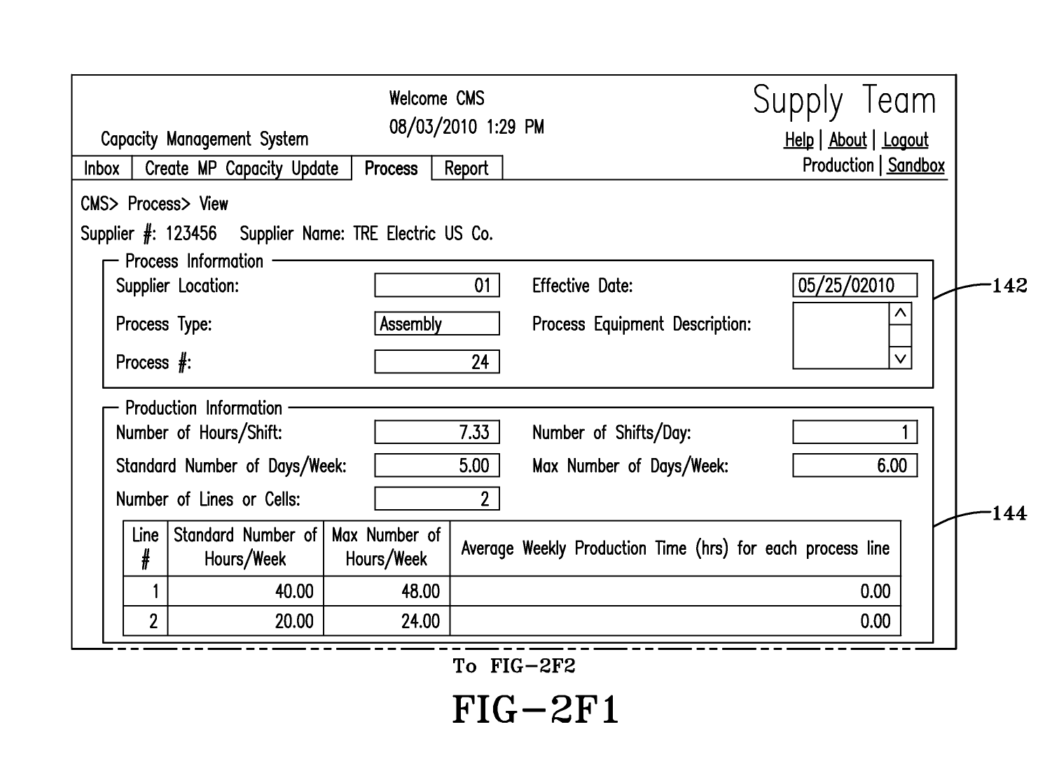

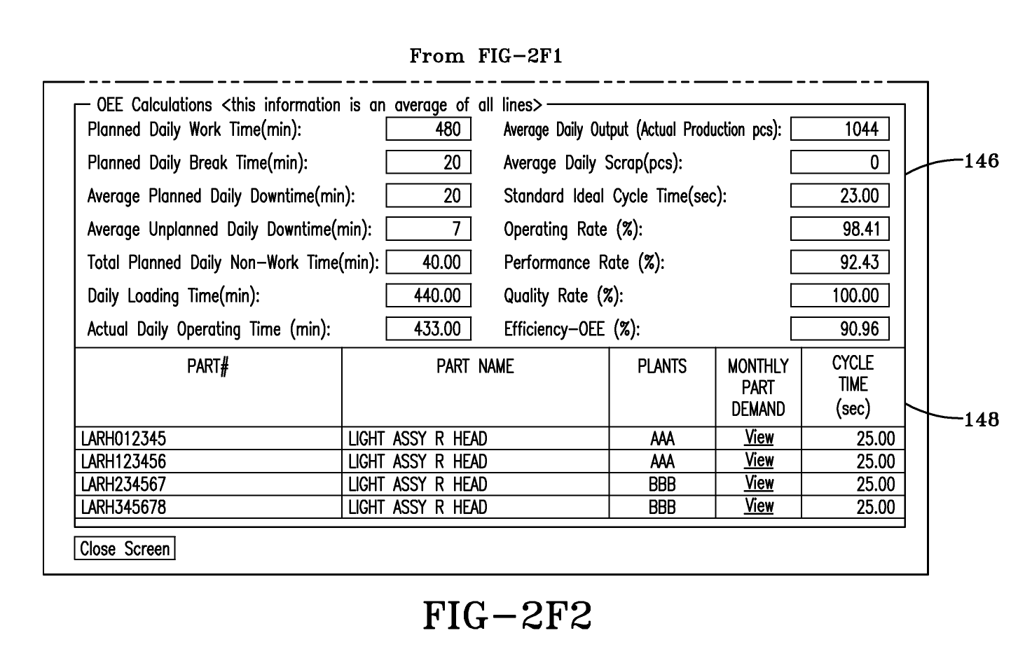

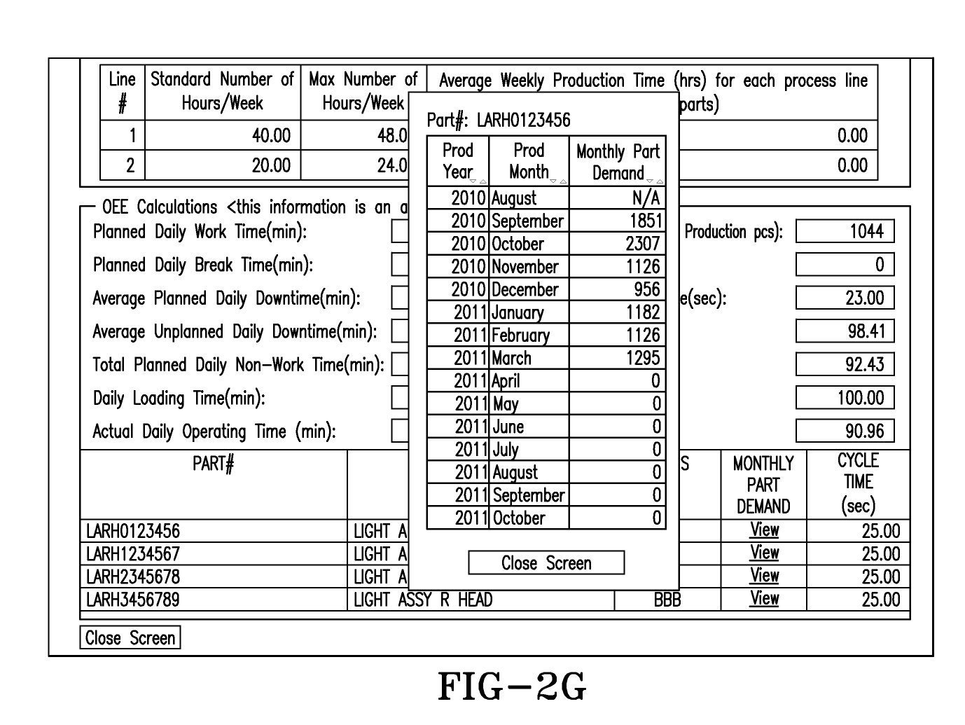

Referring to FIGS. 2A-2G, sample supplier screen displays for an example embodiment are shown. Referring to FIG. 2A, a sample supplier inbox screen display is shown. Capacity requests from the manufacturer may be organized according to the following stages.

TABLE 6
Capacity Response Stages

Pending Responses
Submitted Responses
Approved Responses
Rejected Responses
Draft Responses

Referring to FIG. 2B, a sample submitted responses screen display for an example embodiment is shown. A user from the supplier organization may access this screen to review information regarding responses that it has provided to the manufacturer. Supplier identifying information appears at the top of the display. A list of submitted supplier responses is also displayed on the screen 122. As indicated in FIG. 2B, each response may be assigned a CMS tracking number and is related to a request for a specific event (e.g., new model check 1). In addition, each response is associated with a particular model or process. Filtering options 120 allow the user to change the items appearing in the list.

Referring to FIG. 2C, a sample submitted response details screen display for an example embodiment is shown. Supplier identifying information is displayed near the top of the screen. Capacity request details 124 and model information details 126 are also displayed. A summary of part information (e.g., number and name) for each part in the request is displayed 130 along with status information. Details of the part demand may be viewed by selecting a “part demand view” hyperlink. At the bottom of the screen process data for the related process is displayed 132. An additional capacity/plant layout option indicates whether the supplier has provided additional capacity survey information in the response. A request comments section 128 and a supplier comments section 134 facilitate communication between the manufacturer and supplier and allow representatives from each side to provide additional information related to the request or response.

Referring to FIG. 2D, a process summary display screen for an example embodiment is shown. Supplier identifying information is displayed at the top of the screen 136. The user may enter search and filter criteria 138. A list of processes meeting the search/filter criteria are further displayed on the screen 140. A user may select items from the list to view detailed information regarding submitted capacity responses. Process and part identifying information as well as a status indicator related to the response stage is displayed. In addition, indicators related to whether monthly standard and maximum capacity shortage data is available are displayed. Finally, details of the process capacity history may be viewed.

Referring to FIG. 2E, a demand capacity balance details screen display for an example embodiment is shown. The screen display provides results of the capacity calculation and evaluates shortages for an 18 month horizon.

Referring to FIG. 2F, a sample process details screen display for an example embodiment is shown. The process details screen display comprises various details related to a selected process including process information details 142, production information details including line details 144, efficiency calculations 146, and details about parts that are processed on the line 148. The part data includes a link to demand data for the part as well as cycle time data. As indicated in FIG. 2F, each part may have a different cycle time. Referring to FIG. 2G, a sample pop-up display of demand data from the process details screen is shown.

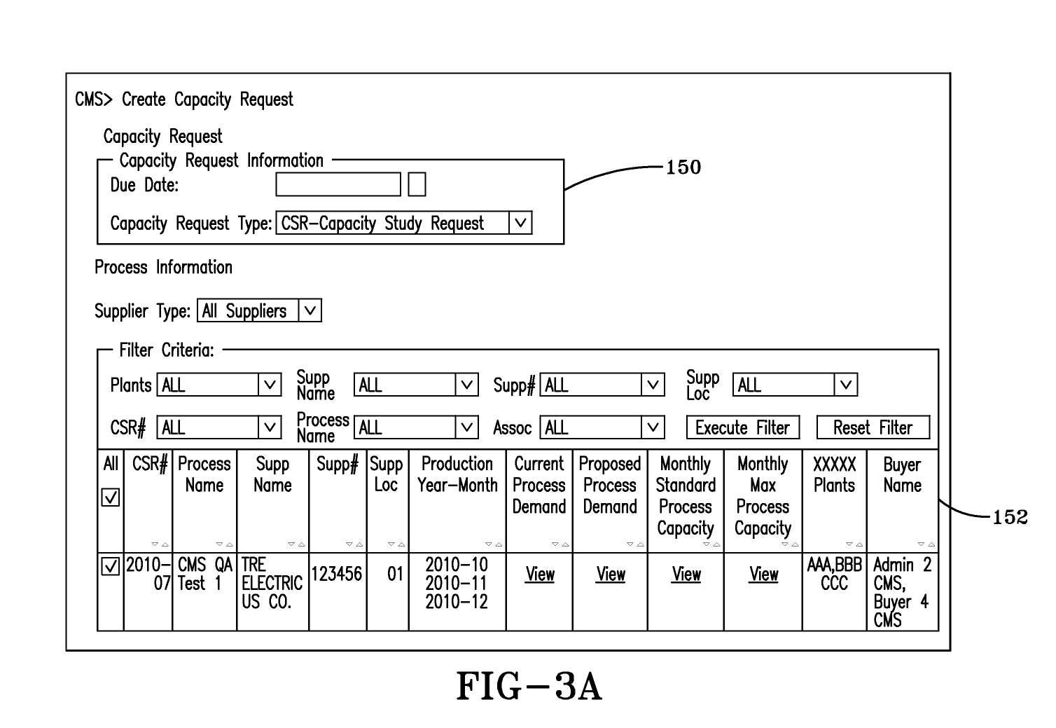

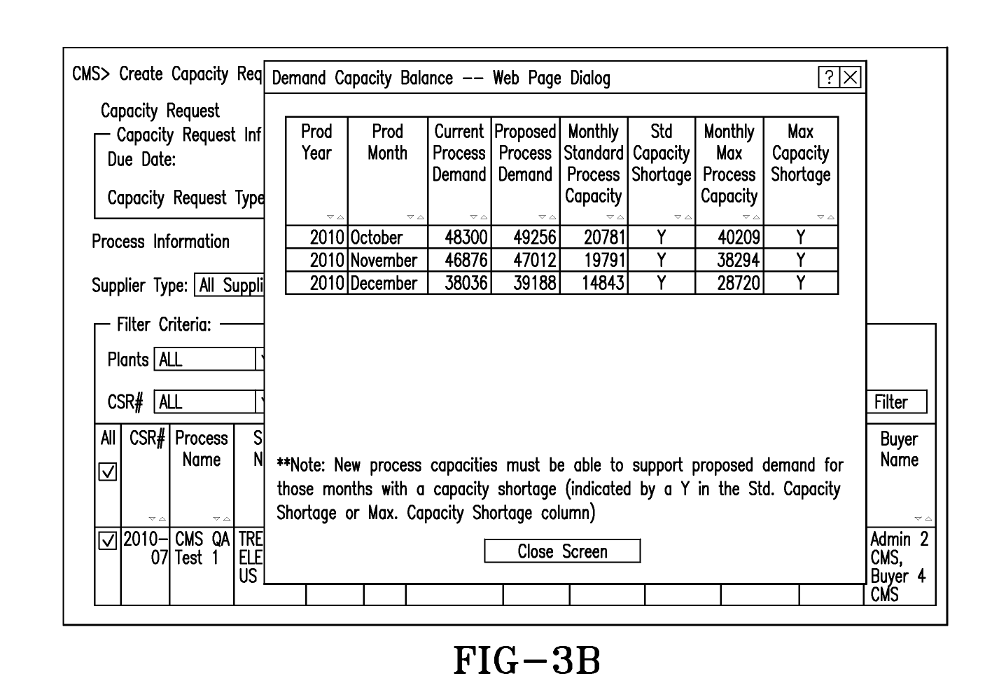

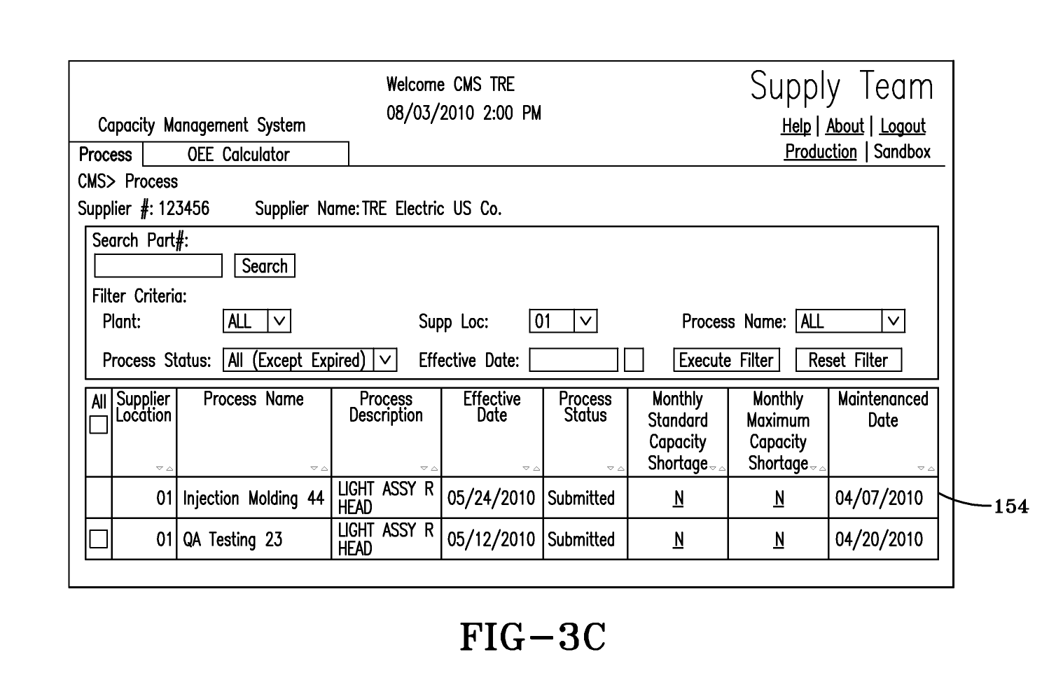

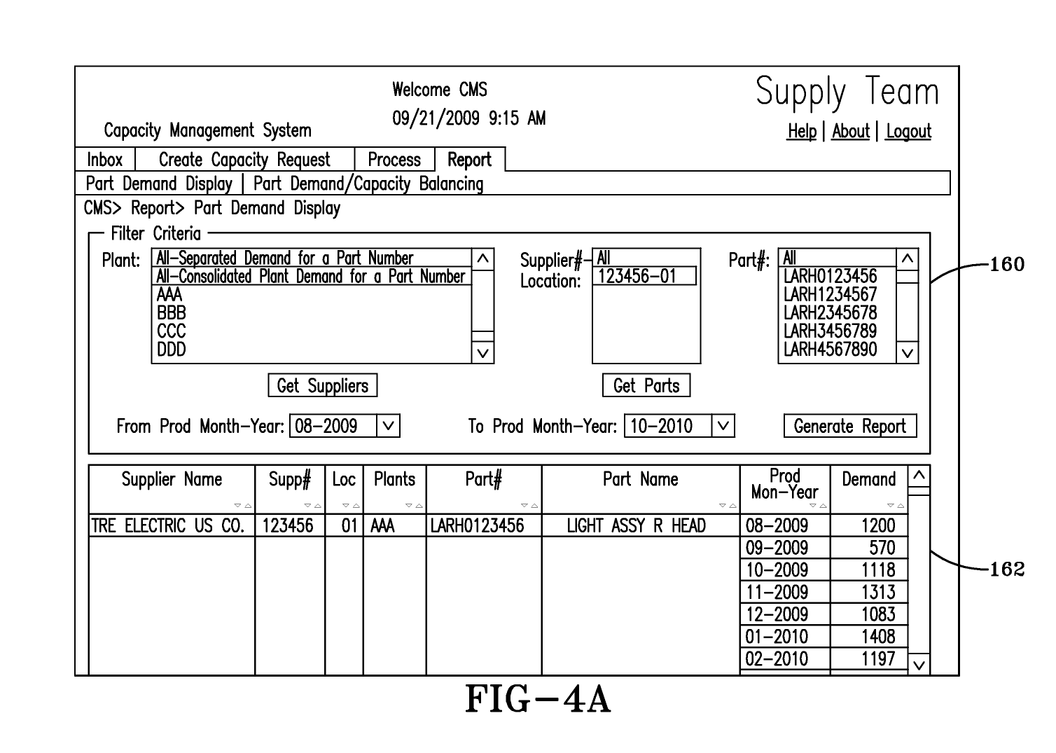

Additional functionality in the computerized system and method captures potential or probable increased capacity based on adjustments to the supplier's manufacturing process. Adjustments that may result in additional capacity include adding plant capacity, adding or improving tooling, increasing production time, reducing lead time for raw materials or components, increasing production rates, building ahead, and instituting overtime. A variety of changes may be implemented at a supplier facility to increase capacity. Screen displays illustrating details of a probable capacity analysis are provided in FIGS. 3A-3C. Referring to FIG. 3A, a capacity study request screen for an example embodiment is shown. The capacity request type is indicated in the capacity request information section 150. A list of study requests that meet specified selection criteria is displayed in a lower portion of the screen 152. In a capacity study request, a supplier may be asked to provide details regarding additional actions that the supplier may take to increase capacity. The actions may relate to countermeasures that may be taken (e.g., extending shifts, adding shifts, adding tools/fixtures, adding capital equipment, address raw material or component part issues, or reconfiguring the manufacturing line) as well as plant modifications that may be made (e.g., building a new plant, expanding a plant, adding new lines/processes/technologies, replacing a current line, or modifying an existing line). The additional information assists the manufacturer in assessing the impact of various changes on the supplier's capacity and whether capacity will increase if certain investments are made.

Referring to FIG. 3B, a balancing information pop-up display for an example embodiment is shown. The display shows current and proposed or probable demand against current capacity to facilitate the effect of various improvements on capacity. Referring to FIG. 3C, a capacity studies display screen according to an example embodiment is shown. A list of processes 154 for which a capacity study has been requested is shown. Details of the proposed changes in capacity to support a study request may be viewed by selecting a process from the list.

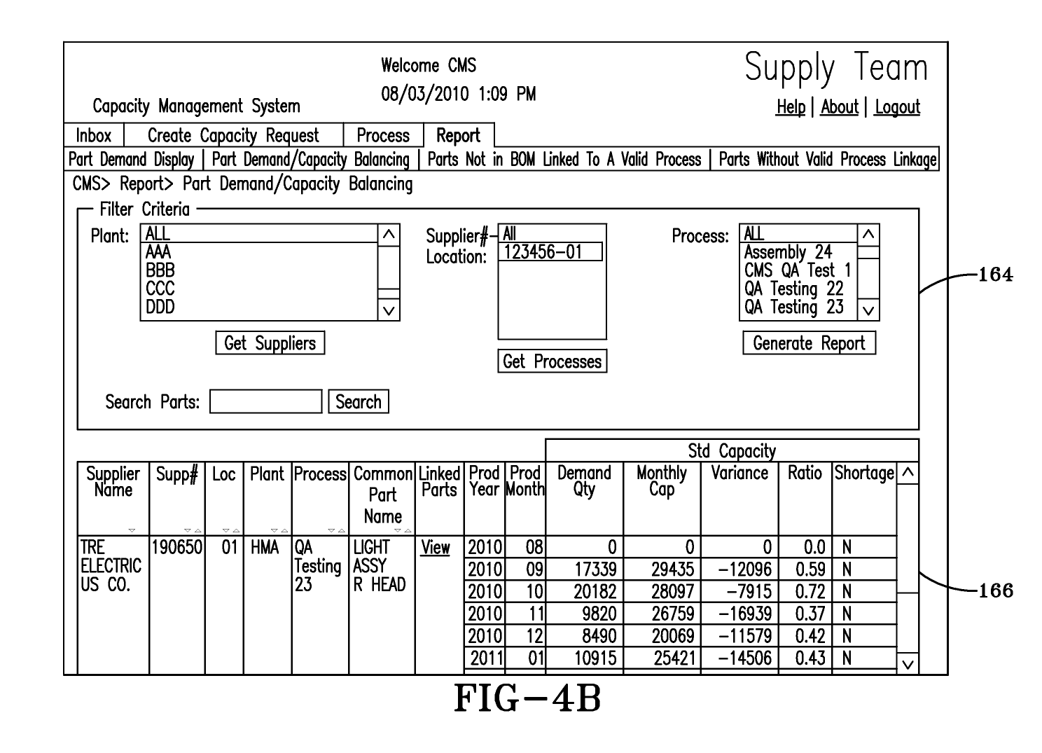

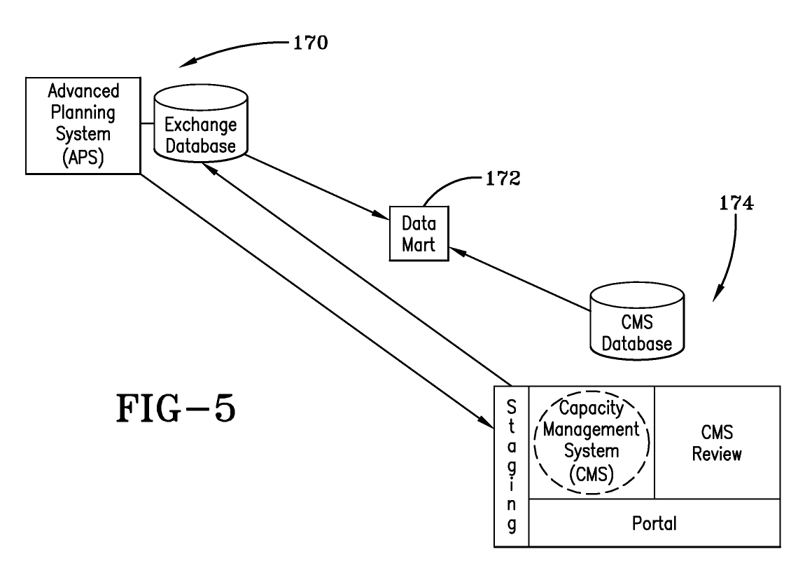

Reporting features for an example embodiment are illustrated in FIGS. 4A and 4B. Referring to FIG. 4A, a sample part demand display screen for an example embodiment is shown. A user enters filter criteria in a top portion of the screen 160 and data meeting the filter criteria is displayed in a bottom portion of the screen 162. Part demand data across multiple manufacturer facilities is accessible from a centralized location so a user may review and analyze the data in a variety of ways. As indicated, a user may view part demand data for a manufacturer plant (all or individual plants), supplier location (all or individual locations), or for part number. The user may further specify a time period to view demand data in relation to the specified time period. Demand data for parts 162 is used in completing the capacity analysis. The demand data may be retrieved from the manufacturer's computerized APS.

Referring to FIG. 4B, a sample part demand/capacity balancing display screen for an example embodiment is shown. Alignment of demand and capacity is “balancing” and is facilitated by features and functionality in the computerized capacity management system and method. The user enters filter criteria in a top portion of the screen 164 and results are displayed in a bottom portion of the screen 166. Monthly standard capacity and maximum capacity values reflect estimates of or probable capacity following modifications and improvements at the supplier's facility to increase production. Demand and capacity data are compared to calculate a variance and ratio reflecting a demand versus capacity balance.

The computerized system and method comprises “dynamic” functionality by considering in the capacity analysis revised vehicle/part number demand data. Dynamic mathematical equations create new “standard” and “maximum” capacity values for each manufacturing process defined in the system. Supplier manufacturing process characteristics reflect changes in demand data to predict new capacity values. In an example embodiment, new part demand data for up to an 18 month period is received nightly from an APS computer. Servers executing APS and capacity management applications may exchange data as illustrated in FIG. 5. Data transfers between the applications may be facilitated through an exchange database 170. In an example embodiment, a calculate part demand operation executes nightly in the APS computer 170. The part demand data (18 month) is extracted and transferred to the CMS computer 174. The new part demand data is used to calculate a new monthly standard capacity and monthly maximum capacity for each month in an 18 month horizon. The new capacity values for the 18 month horizon are extracted at the CMS computer 174, and then transferred to the APS computer 170. Each system, therefore, has current data from the other that may be used in further calculations and analysis. Certain data may also be written to a data mart 172 for reporting and historical purposes.

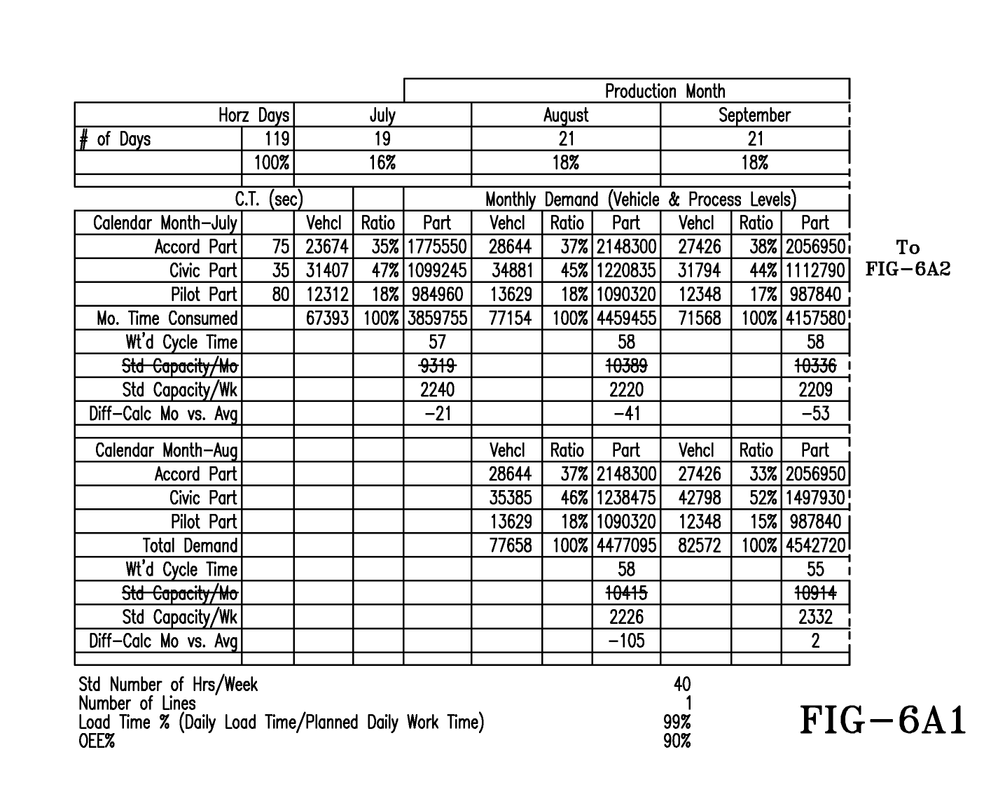

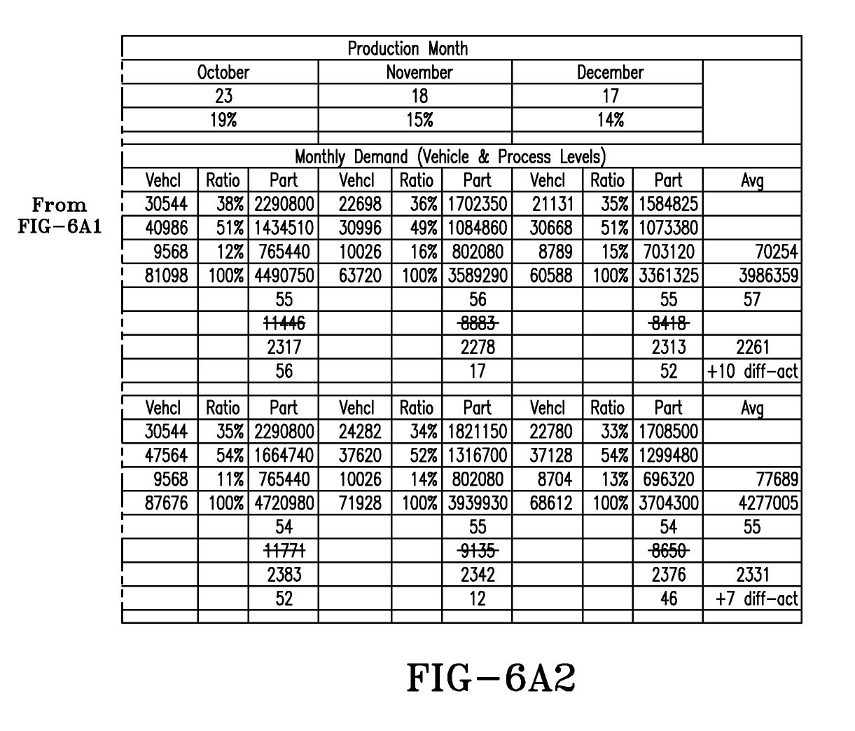

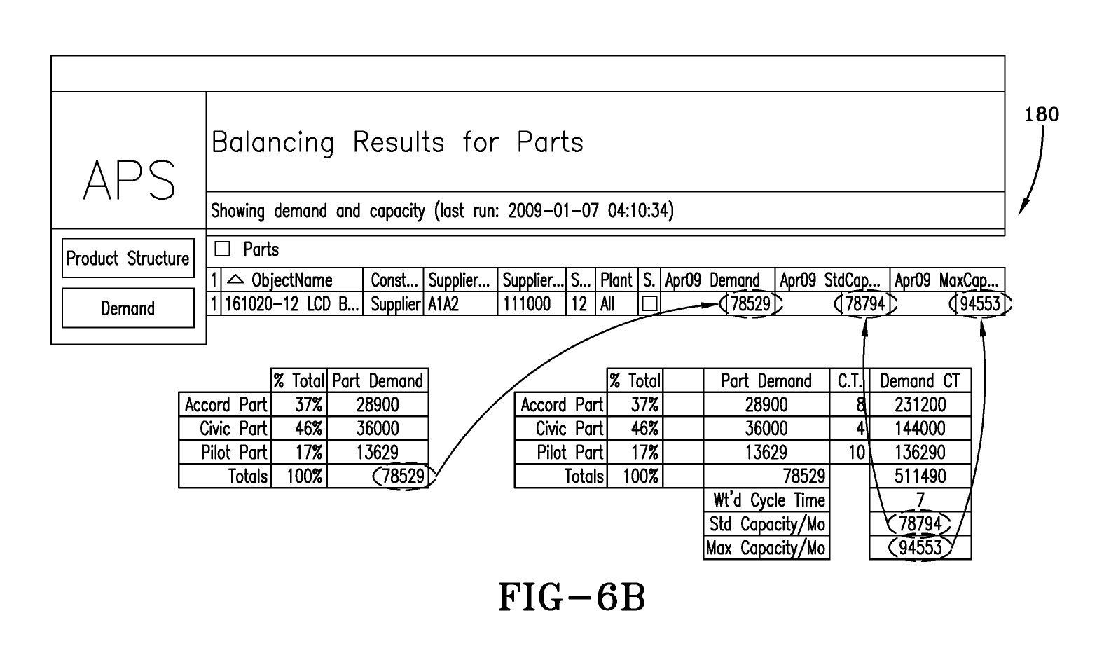

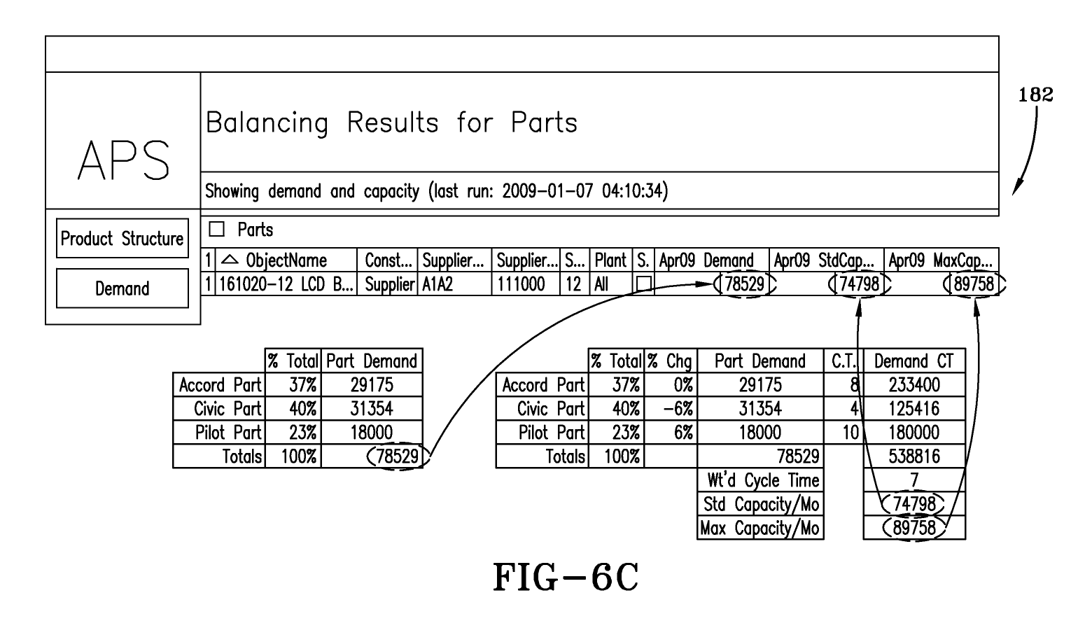

Referring to FIG. 6A, sample dynamic capacity impact calculation details are provided for an example embodiment. For each production month, monthly demand at the vehicle and process levels is determined. The chart illustrates the impact of changes to the demand mix for products over a multi-month horizon. In an example embodiment, the following rules are applied in the calculations:

TABLE 7
Dynamic Capacity Impact Calculation Rules

| Calculation | Rule |
|---|---|
| Monthly Time | System calculates for 18 months in CMS = |
| Consumed on | part number monthly demand × part cycle time |
| Process by | |
| Part Number | |
| Weighted | SUM(monthly time consumed on process by part |
| Average Cycle | number)/SUM(part number demand) |
| Time for | |
| Process | |
| Monthly | System calculates for 18 months in CMS = |
| Standard | ((((((standard number of hours/week <sum for |
| Capacity | all lines> - “average weekly production |
| | time for non-manufacturer parts (hours)” |
| | <sum for all lines>)) * (daily load time/ |
| | planned daily work time) * 60 *60)/weighted |
| | average cycle time for process) * OEE %)/standard |
| | working days in a week) * working days in the |
| | month) * (remaining calendar days in the |
| | calculated month starting from effective date/ |
| | total calendar days in the calculated month. |
| | Monthly maximum capacity is also recalculated. |

FIGS. 6B and 6C illustrate details of demand/capacity balancing for an example embodiment. As indicated previously, “balancing” is the process of aligning demand and capacity. Referring to FIG. 6B, screen displays comprise demand data from the APS and capacity data from CMS for each part. A first balancing scenario 180 indicates that the process has enough capacity to handle the demand. An indicator in the status column (e.g., N for normal) reflects the status of the balance. Referring to FIG. 6C, a second balancing scenario 182 shows the result after the demand mix change and a dynamic recalculation of standard and maximum capacities. The rebalancing indicates the process has now exceeded its standard capacity and that it is utilizing its maximum capacity. An indicator in the status column (e.g., W for warning) reflects the status. The capacity recalculation and related indicator information notifies the manufacturer if a supplier's capacity is sufficient or if the capacity is otherwise unbalanced in relation to demand.

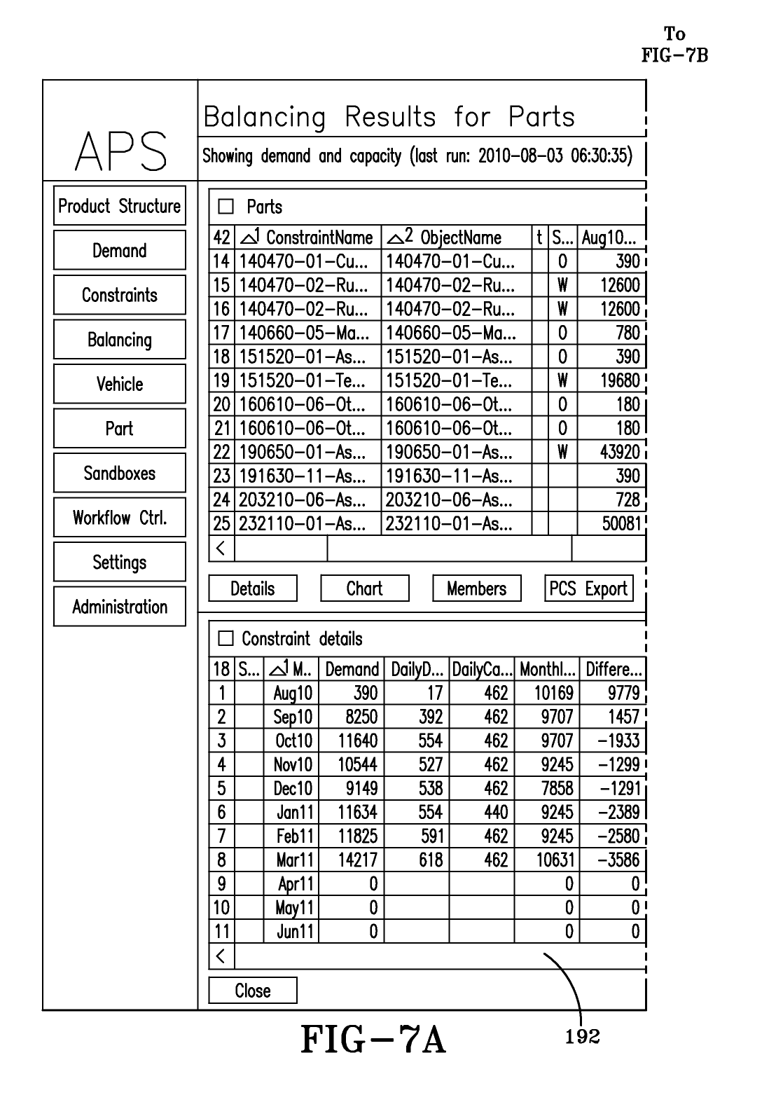

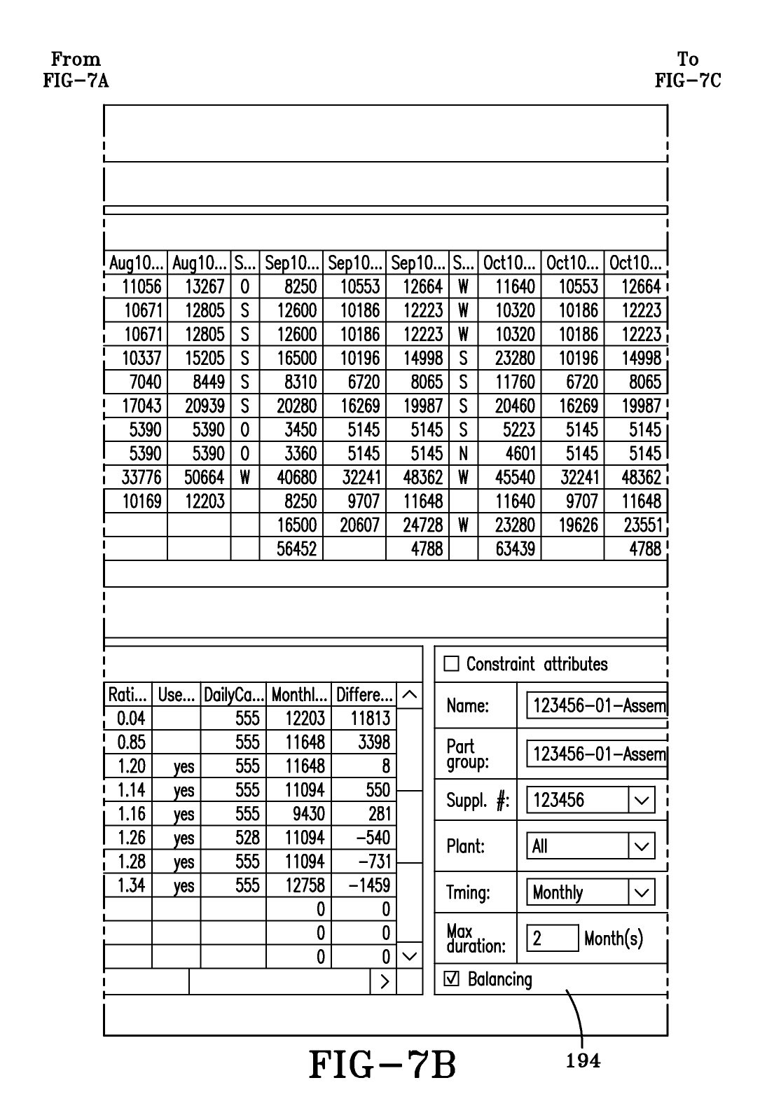

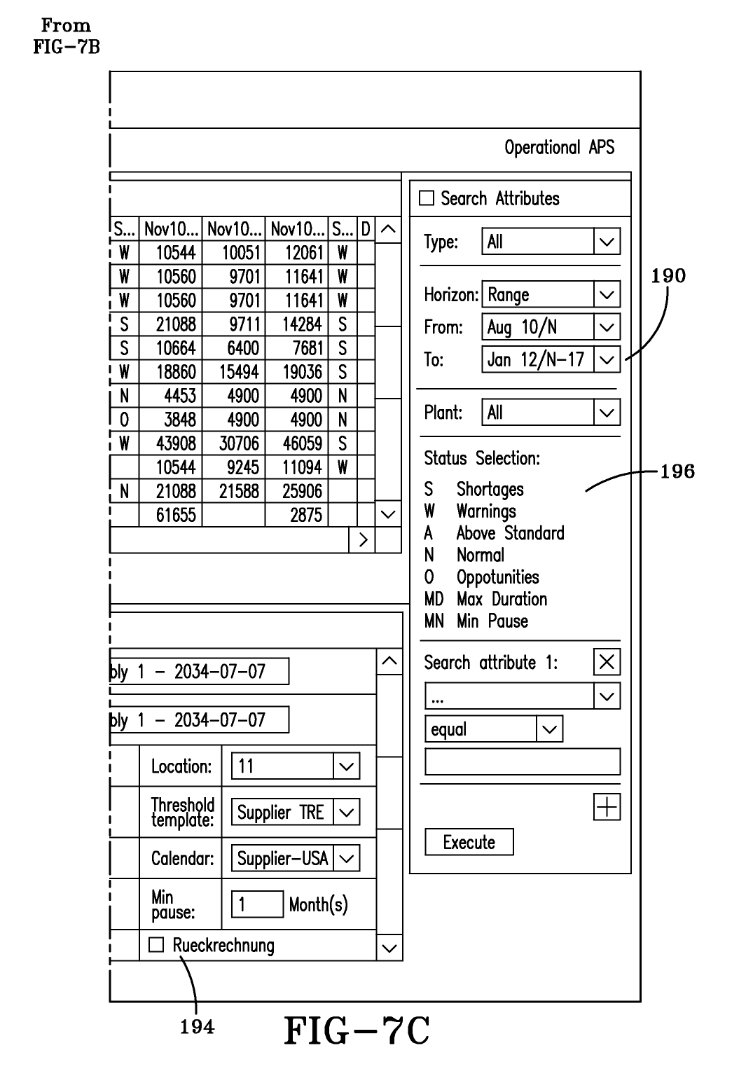

Referring to FIG. 7, a sample balancing results screen display for an example embodiment is shown. The screen display comprises supplier and part constraint data. Process/line/machine identifying information is provided along with all parts produced on the process. In addition, balancing indicators are shown. In an example embodiment, the following indicators may be used:

TABLE 8
Balancing Indicators 196

| | |
|---|---|
| S | Shortage - demand exceeds maximum capacity |
| W | Warning - demand value within a threshold of maximum |
| | capacity value |
| A | Above standard - demand above standard capacity value |
| N | Normal - demand within a threshold of standard capacity |
| O | Opportunities - demand below standard capacity value |

Constraint details 192 as well as constraint attributes 194 may be displayed on the screen. Details appearing on the screen may be modified according to various selection criteria 190.

The computerized capacity management system and method supports integration of various business practices across a manufacturer's supply chain and factories. Requests for capacity data initiated by the manufacturer and responses received from suppliers are tracked and monitored. In response to requests, capacity data is collected, checked, and approved. Capacity shortages and opportunities are identified. Finally, the computerized capacity management system and method assists the manufacturer and supplier in researching methods to increase capacity values. The use of a portal environment facilitates manufacturer and supplier execution of various functions in the computerized system and method and supports communications of various activities in a real time mode.

A computerized dynamic capacity management system and method is described in reference to the appended figures. The description with reference to figures is made to exemplify the disclosed computerized dynamic capacity management system and method and is not intended to limit the system and method to the representations in the figures. From the foregoing description, it can be understood that there are various ways to construct a capacity management system and method while still falling within the scope of the present invention. As such, while certain embodiments of the present invention are described in detail above, the scope of the invention is not to be considered limited by such disclosure, and modifications are possible without departing from the spirit of the invention as evidenced by the following claims:

What is claimed is:

1. A computerized capacity management method comprising:
(a) receiving at a computer server supplier process data for a plurality of supplier processes, said supplier process data comprising for each process:
(1) a process identifier for said process;
(2) a plurality of capacity calculation parameters; and
(3) a demand value for each part produced using said process;
(b) calculating a capacity value for each of said plurality of processes using said plurality of capacity calculation parameters and said demand values; and
(c) generating at said computer server a display screen comprising for each process a process identifier and an associated capacity value; and
(d) displaying said screen at a user computer.

2. The computerized method of claim 1 wherein said capacity value is selected from the group consisting of a standard capacity value and a maximum capacity value.

3. The computerized method of claim 1 further comprising:
(e) receiving at said computer server a revised demand value for at least one process; and
(f) recalculating at said computer server said capacity value using said revised demand value.

4. The computerized method of claim 1 further comprising:
(e) receiving at said computer server additional capacity data related to improvements to said process to increase capacity; and
(f) calculating at said computer server a probable capacity value using said additional capacity data.

5. The computerized method of claim 4 wherein said additional capacity data comprises improvements selected from the group consisting of:
extending a shift, adding a shift, adding a tool, adding capital equipment, addressing raw material or component part issues, reconfiguring the process line, adding new a process line, adding a new technology the process line, replacing the process line, expanding the process plant, and building a new plant.

6. The computerized method of claim 1 further comprising:
for at least one supplier process
(e) comparing said demand value to said capacity value;
(f) providing in said display an indicator of alignment between said demand value and said capacity value.

7. The computerized method of claim 1 wherein said capacity value is a standard capacity value.

8. The computerized method of claim 7 further comprising calculating a maximum capacity value.

9. The computerized method of claim 8 further comprising displaying at said user computer an indicator selected from the group consisting of:
demand value exceeds a standard capacity value;
demand value within a threshold of a standard capacity value;
demand value below a standard capacity value;
demand value within a threshold of maximum capacity value;
demand value below a maximum capacity value; and
demand value above a maximum capacity value.

10. The computerized method of claim 1 further comprising:
(e) initiating from said server computer requests to suppliers to provide said supplier process data; and
(f) displaying at a user computer status details related to said requests to suppliers to provide said supplier process data.

11. A computerized capacity management system comprising:
(a) a computer database storing supplier process data for a plurality of supplier processes, said supplier process data comprising:
(1) a process identifier for a process;
(2) a plurality of capacity calculation parameters; and
(3) a demand value for each part produced using said process;
(b) a computer server for:
(i) calculating a capacity value for each of said plurality of processes using said plurality of capacity calculation parameters and said demand values; and
(ii) generating at said computer server a display screen comprising for each process a process identifier and an associated capacity value; and
(c) a user computer for displaying said screen.

12. The computerized system of claim 11 wherein said capacity value is selected from the group consisting of a standard capacity value and a maximum capacity value.

13. The computerized system of claim 11 wherein said server computer:
receives a revised demand value for at least one process; and
recalculates said capacity value using said revised demand value.

14. The computerized system of claim 11 wherein said server computer:
receives additional capacity data related to improvements to at least one process to increase capacity; and
calculates a probable capacity value using said additional capacity data.

15. The computerized system of claim 14 wherein said additional capacity data comprises improvements selected from the group consisting of:
extending a shift, adding a shift, adding a tool, adding capital equipment, addressing raw material or component part issues, reconfiguring the process line, adding new a process line, adding a new technology the process line, replacing the process line, expanding the process plant, and building a new plant.

16. The computerized system of claim 11 wherein said server computer:
for at least one supplier process
compares said demand value to said capacity value; and
provides in said display an indicator of alignment between said demand value and said capacity value.

17. The computerized system of claim 11 wherein said capacity value is a standard capacity value.

18. The computerized system of claim 17 wherein said server computer further calculates a maximum capacity value.

19. The computerized system of claim 18 wherein said user computer displays an indicator selected from the group consisting of:
demand value exceeds a standard capacity value;
demand value within a threshold of a standard capacity value;
demand value below a standard capacity value;
demand value within a threshold of maximum capacity value;
demand value below a maximum capacity value; and
demand value above a maximum capacity value.

20. The computerized system of claim 11 wherein said server computer:
initiates requests to suppliers to provide said supplier process data; and
displays at said user computer status details related to said requests to suppliers to provide said supplier process data.

21. A computerized method for displaying supplier capacity data comprising:
(a) receiving at a computer server supplier process data for a plurality of supplier processes, said supplier process data comprising for each process:
(1) a process identifier for said process;
(2) a plurality of capacity calculation parameters; and
(3) a demand value for each part produced using said process;
(b) calculating a capacity value for each of said plurality of processes using said plurality of capacity calculation parameters and said demand values; and
(c) generating at said computer server a display screen comprising for each process a process identifier and an associated capacity value; and
(d) displaying said screen at a user computer;
(e) receiving at said computer for each of said plurality of supplier processes a revised demand value for each part produced using said process;
(f) recalculating a capacity value for each of said plurality of processes using said plurality of capacity calculation parameters and said revised demand values; and
(g) generating at said computer server an updated display screen comprising for each process a process identifier and a recalculated capacity value; and
(h) displaying said updated display screen at said user computer.

22. The computerized method of claim 21 wherein said capacity value is selected from the group consisting of a standard capacity value and a maximum capacity value.

23. The computerized method of claim 21 further comprising displaying at said user computer a status indicator related to said capacity value.

24. The computerized method of claim 23 wherein said indicator is selected from the group consisting of:
demand value exceeds a standard capacity value;
demand value within a threshold of a standard capacity value;
demand value below a standard capacity value;
demand value within a threshold of maximum capacity value;
demand value below a maximum capacity value; and
demand value above a maximum capacity value.

25. The computerized method of claim 21 further comprising:
(i) initiating from said server computer requests to suppliers to provide said supplier process data; and
(j) displaying at a user computer status details related to said requests to suppliers to provide said supplier process data.
